(19) United States
(12) Patent Application Publication
(10) Pub. No.: US 2016/0221663 A1
(43) Pub. Date: Aug. 4, 2016

(54) FLIGHT CONTROL COMPUTER FOR AN AIRCRAFT THAT INCLUDES AN INERTIAL SENSOR INCORPORATED THEREIN

(71) Applicant: Gulfstream Aerospace Corporation, Savannah, GA (US)

(72) Inventor: Thomas Landers, Savannah, GA (US)

(21) Appl. No.: 14/574,496

(22) Filed: Dec. 18, 2014

(51) Int. Cl. B64C 13/50; B64D 43/00

(52) U.S. Cl. CPC B64C 13/503; B64D 43/00

(57) ABSTRACT

The disclosed embodiments relate to a flight control computer for an aircraft. The flight control computer includes an inertial sensor integrated or incorporated within the flight control computer.

### TECHNICAL FIELD

Embodiments of the present invention generally relate to aircraft, and more particularly relate to a flight control computer for an aircraft that includes inertial sensor(s) integrated within the flight control computer.

### BACKGROUND OF THE INVENTION

Modern aircraft are often equipped with a flight control computer that is part of a “fly-by-wire” control system. In a typical, fly-by-wire airplane, electronic sensors are attached to the pilot's controls. These sensors transmit electronic data to various flight control computers. Actuator control electronics receive the electronic signals from the flight control computer and move hydraulic actuators based on the received signals. For example, each hydraulic actuator is coupled to a moveable surface such that movement of the actuator moves the primary control surface. The fly-by-wire concept results in a savings of weight as there is no longer a need for heavy linkages, cables, pulleys, and brackets running throughout the airplane to control the actuators, only electrical wiring to the flight control computer and the actuator control electronics. Furthermore, this concept may result in a smoother flight, with less effort needed by the pilot.

Many newer aircraft also employ an integrated air data inertial reference system (ADIRS). Some ADIRS can include air data inertial reference units (IRUs) located in the aircraft.

Each air data inertial reference unit (IRU) includes air data reference (ADR) components and an inertial reference (IR) components that each include a variety of different sensors and devices used to acquire information that can be used to determine/compute airspeed, Mach number, angle of attack, temperature and barometric altitude data, attitude, flight path vector, ground speed and positional data, etc. The ADR components can supply information about air data (e.g., airspeed, angle of attack and altitude), and the IR components can supply inertial reference information (e.g., position and attitude). This information can be provided to the pilots' electronic flight instrument system displays, as well as to other systems on the aircraft such as the engine electronic control computers, autopilot computers, flight control computers, landing gear systems, etc.

As such, aircraft that implement fly-by-wire systems include a number of different sensors that are located throughout the aircraft. For safety reasons, it is often preferable to include redundant versions of these sensors in case they are needed. This not only requires additional sensors mounted throughout the aircraft, but also wired connections between these redundant sensors, the flight control computer and power supplies for the redundant sensors.

There is a need for an aircraft that includes a low cost avionics system with redundant sensors. It would be desirable to eliminate at least some of the wiring needed in such an avionic system. Furthermore, other desirable features and characteristics of the present invention will become apparent from the subsequent detailed description and the appended claims, taken in conjunction with the accompanying drawings and the foregoing technical field and background.

### SUMMARY

The disclosed embodiments relate to an aircraft and a flight control computer that can be used in the aircraft. The flight control computer includes at least one inertial sensor that is incorporated or integrated within the flight control computer. For instance, in one implementation, the inertial sensor can be integrated within a processor of the flight control computer.

### DESCRIPTION OF THE DRAWINGS

Embodiments of the present invention will hereinafter be described in conjunction with the following drawing figures, wherein like numerals denote like elements, and

FIG. 1 is a perspective view of an aircraft in which the disclosed embodiments can be implemented in accordance with one non-limiting implementation.

FIGS. 2A through 2C are front, side and top perspective views, respectively, of an aircraft in which the disclosed embodiments can be utilized in accordance with one non-limiting implementation.

FIG. 3 is a block diagram of an aircraft avionics and fly-by-wire flight control system that includes a flight control computer in accordance with an exemplary implementation of the disclosed embodiments.

FIG. 4 is a block diagram of a flight control computer in accordance with one exemplary implementation of the disclosed embodiments.

FIG. 5 is a block diagram of a flight control computer having a processor with integrated sensors in accordance with other disclosed embodiments.

### DESCRIPTION OF EXEMPLARY EMBODIMENTS

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary or the following description.

The disclosed embodiments relate to a flight control computer that includes inertial sensor(s) integrated within the flight control computer. The inertial sensor(s) can be, for example, sensors such as accelerometer(s) and/or gyroscope(s). In one implementation, the inertial sensor(s) can be integrated within a processor of the flight control computer. The inertial sensor(s) can generate inertial signal data that can be processed by the processor to generate control commands that are used to control flight control surfaces of the aircraft. The disclosed embodiments can eliminate the need for separate wired connections that are normally needed between the flight control computer and inertial sensor(s), and between the power supply and the inertial sensor(s). The inertial sensor(s) can be redundant versions of external inertial sensor(s) that are coupled to the flight control computer via wired connections. This way, when inertial sensor data is unavailable from the external inertial sensor(s), the inertial sensor(s) that are integrated within the flight control computer can be used as a backup to generate control commands that can be used, for example, to control flight control surfaces of the aircraft.

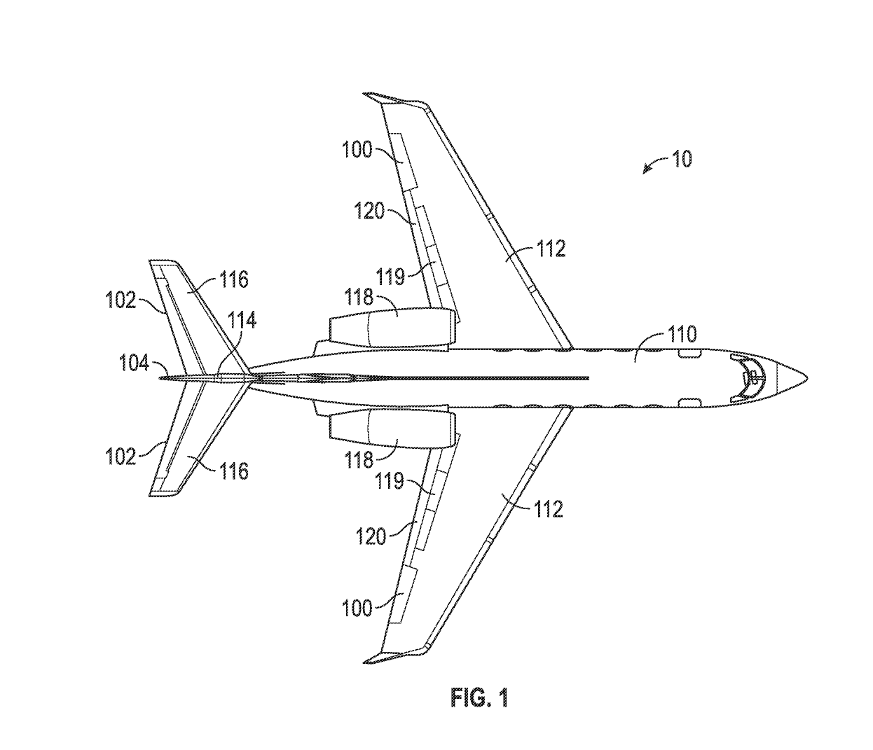

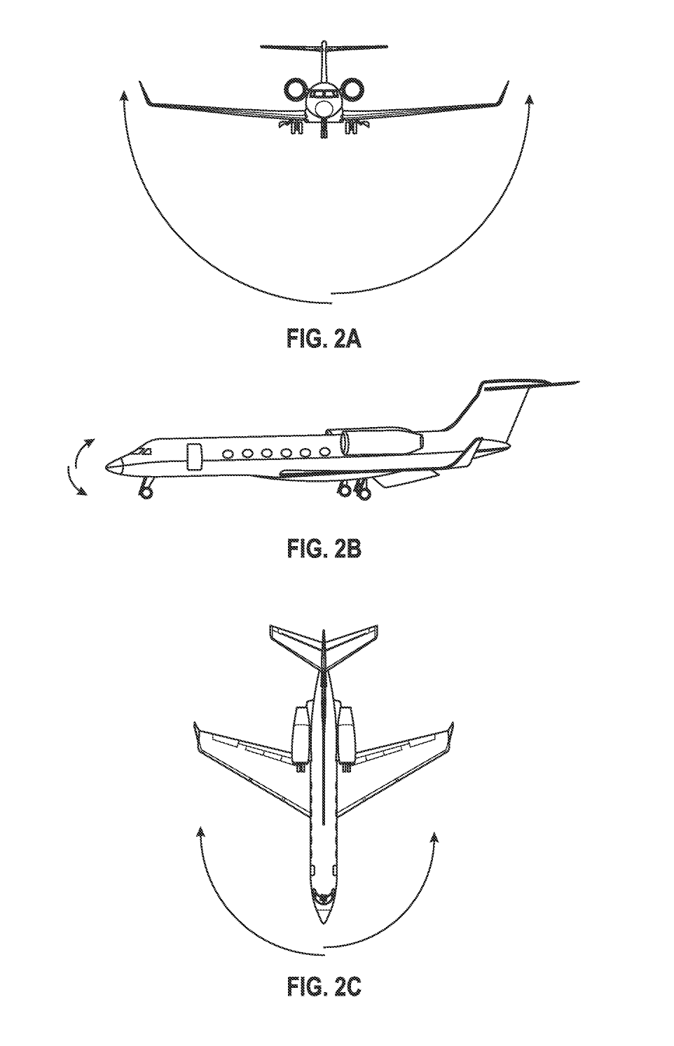

FIG. 1 is a perspective view of an aircraft 10 in which the disclosed embodiments can be implemented in accordance with one exemplary, non-limiting implementation. FIGS. 2A through 2C are front, side and top perspective views, respectively, of an aircraft 10 in which the disclosed embodiments can be implemented in accordance with one exemplary, non-limiting implementation. FIGS. 2A through 2C show three axes about which an aircraft 10 can be controlled.

In accordance with one non-limiting implementation of the disclosed embodiments, the aircraft 10 includes fuselage 110, which holds the passengers and the cargo; two main wings 112, which provide the lift needed to fly the aircraft 10; a vertical stabilizer 114 and two horizontal stabilizers 116, which are used to ensure a stable flight; and two jet engines 118, which provide the thrust needed to propel the aircraft 10 forward. Flight control surfaces are placed on wings 112, horizontal stabilizers 116, and vertical stabilizers 114 to guide the aircraft 10. Flight control surfaces can include primary and secondary flight control surfaces.

The primary flight control surfaces include the ailerons 100 located on the trailing edges of the wings of the aircraft 10, the elevators 102 located on the horizontal stabilizer of an aircraft 10, and the rudder 104 located on the vertical stabilizer. The primary flight control surfaces are operated by a pilot located in the cockpit of the aircraft 10. The ailerons 100 control the roll of the aircraft 10. The ailerons 100 can be controlled, for example, by adjusting a control yoke to the left or right. For example, moving the control yoke to the left typically controls the left aileron to rise and the right aileron to go down, causing the aircraft 10 to roll to the left. Rolling of an aircraft 10 is depicted in FIG. 2A. The elevators 102 control the pitch of the aircraft 10. The elevators 102 can be controlled, for example, by adjusting a control yoke to the front or back. Pitching of an aircraft 10 is depicted in FIG. 2B. The rudder 104 controls the yaw of the aircraft 10. The rudder 104 can be controlled, for example, by a pair of rudder pedals operated by the pilot's feet. Yawing of an aircraft 10 is illustrated in FIG. 2C.

The secondary flight control surfaces can include spoilers 119 and flaps 120 on the wings 112 of the aircraft 10. Flaps 120 are provided at the trailing edges of wings 112. Spoilers 119 perform a variety of different functions, including assisting in the control of vertical flight path, acting as air brakes to control the forward speed of the aircraft 10, and acting as ground spoilers to reduce wing lift to help maintain contact between the landing gear and the runway when braking. Flaps 120 change the lift and drag forces effecting an aircraft 10. When flaps 120 are extended the shape of the wing changes to provide more lift so that the aircraft 10 is able to fly at lower speeds, thus simplifying both the landing procedure and the take-off procedure.

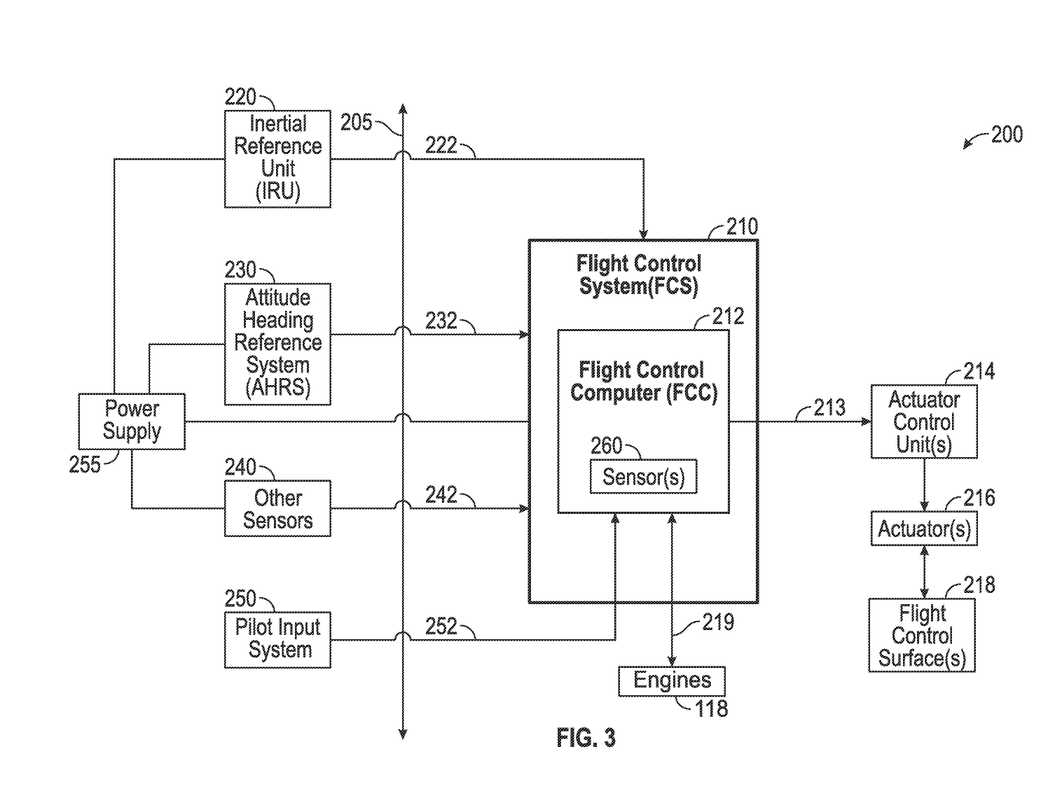

Although not shown in FIG. 1, the aircraft 10 also includes various onboard computers, aircraft instrumentation and various control systems. These onboard computers can include flight control computers and the aircraft instrumentation can include various sensors that make up portions of an avionics system as will now be described with reference to FIG. 3.

FIG. 3 is a block diagram of an aircraft avionics and fly-by-wire flight control system that includes a flight control computer 212 in accordance with an exemplary implementation of the disclosed embodiments.

The system 200 comprises a flight control system (FCS) 210, an actuator control unit 214, actuators 216, various flight control surfaces 218, at least one Inertial Reference Unit (IRU) 220, at least one Attitude Heading Reference System (AHRS) 230, other sensors 240, and a pilot input system 250, and a power supply that supplies power via wired connections to at least the FCS 210, the IRU 220, the AHRS 230, and the other sensors 240. The system 200 can also include other elements including flight displays, etc. that are not illustrated for sake of simplicity. Although not illustrated, it will be appreciated that an aircraft can include any appropriate number of redundant avionics systems or any number of the sub-systems that make up the avionics system 200.

The IRU 220 includes devices, components and sensors such as gyroscope(s) (e.g., ring laser gyroscope(s)), accelerometer(s), Global Position System (GPS) receiver(s), and other motion sensor devices). For example, the IRU 220 can include ring laser gyroscope(s) and accelerometer(s) that can sense information that can be used to compute or generate inertial signal data 222 that is provided to the flight control system 210. The inertial signal data 222 can generally include inertial flight data such as angular rates of the aircraft rates (e.g., angular rates of roll, pitch and yaw axes) and linear accelerations, as well as the aircraft attitude and velocity.

Like the IRU 220, the AHRS 230 includes sensor devices such as gyroscopes, accelerometers and/or magnetometers that are not illustrated for sake of simplicity. The AHRS 230 also includes a processor and software for processing information from the various sensor devices to generate inertial flight control data 232 that it provides to the flight control system 210 and its flight control computer 212. For example, in some implementations, the AHRS 230 includes three sensors for the three axes of the aircraft that can provide heading, attitude and yaw measurement data for each of the three axes of the aircraft. This heading, attitude and yaw measurement data can processed via a processor at the AHRS 230 to provide the inertial flight control data 232 (e.g., rates, accelerations, attitude and heading measurement data) directly to the flight control computer 212.

Depending on the implementation, this inertial flight control data 232 can include at least some of the inertial signal data 222 that is described above with respect to the IRU 220. As such, in some embodiments, the IRU 220 and the AHRS 230 output substantially similar types of data (e.g., rates, accelerations, attitude and heading measurements) to the flight control system 210 and its flight control computer 212. In other words, the inertial signal data 222 and the inertial flight control data 232 are “redundant” to a certain extent. The inertial flight control data 232 from the AHRS 230 can be used to check or confirm the correctness of the inertial signal data 222 that is output by the IRU 220.

The other sensors 240 can include, for example, air data sensors, air data reference (ADR) components or sensors, acoustic sensors (e.g., sound, microphone, seismometer, accelerometer, etc.), vibration sensors, aircraft sensors (e.g., air speed indicator, altimeter, attitude indicator, gyroscope, magnetic compass, navigation instrument sensor, speed sensors, angular rate sensor, etc.), position, angle, displacement, distance, speed, acceleration sensors (e.g., accelerometer, inclinometer, position sensor, rotary encoder, rotary/linear variable differential transformer, tachometer, etc.). The other sensors 240 can also include pitot and static pressure sensors that can be used to measure Ram air pressure and static pressures, and provide data or information that can be used to determine/compute airspeed, Mach number, angle of attack, temperature and barometric altitude data, etc. The other sensors 240 can also include Global Positioning System (GPS), Global Navigation Satellite System (GNSS), or other satellite based sensor systems.

The pilot input system 250 generates various pilot input signals in response to inputs from the pilot. The pilot input signals can be generated in response to the pilot adjusting a control stick to the left or right, adjusting a control wheel or control stick to the front or back, adjusting a rudder pedal, etc.

The flight control system 210 includes a flight control computer 212. The flight control computer 212 receives pilot input signals 252 and based on these signals and other information generates engine control signals 219 that control the engines 118, and control commands 213 that control the various flight control surfaces (e.g., ailerons 100, elevators 102, rudder 104, spoilers 119, flaps 120) of the aircraft. The flight control computer 212 is configured to operate the various flight control surfaces 218 on an aircraft by issuing control commands 213 to an actuator control unit 214 (or multiple actuator control units) that controls actuators 216 coupled to the various flight control surfaces 218 to provide a desired flight operation in response to various criteria. The flight control computer 212 can receive input signals 222, 232, 242 from the IRU 220, the AHRS 230, and other sensors 240, respectively. Examples of input signals 222, 232 can include signals that provide information regarding rates (e.g., angular body rate signals), acceleration signals, altitude signals, attitude signals, speed signals, heading signals, etc. Input signals 242 from the other sensors can include various air data reference signals such as airspeed, altitude, and air temperature, as well as signals from any other type of sensors that are part of the aircraft. The flight control computer 212 also receives pilot input signals from the pilot input system 250.

The flight control computer 212 processes the pilot input signals 252 and at least some of the input signals 222, 232, 242 to translate the pilot input signals into commands 213 for use by the actuator control unit 214. Although FIG. 3 illustrates a single flight control computer 212, those skilled in the art will appreciate that this block can represent multiple flight control computers (not illustrated) that receive the various inputs 222, 232, 242, 252 and use these inputs to control one of the various flight control surfaces 218. Likewise, there can be multiple actuator control units 216 that each control actuators associated with one of the various flight control surfaces 218.

As described above with reference to FIGS. 1 and 2, the aircraft includes various primary flight control surfaces (e.g., one aileron 100 on each wing 112, one elevator 102 on each horizontal stabilizer 116, and one rudder 104 on the vertical stabilizer 114) and secondary flight control surfaces (e.g., spoilers 119, flaps 120, on the wings 112). Each flight control surface typically has one or more actuators for controlling its movement. The actuator control unit 214 transmits control signals 215 to actuators 216. The actuators 216 generate signals 217 that control movement of the various flight control surfaces 218 of the aircraft in accordance with the control signals 215.

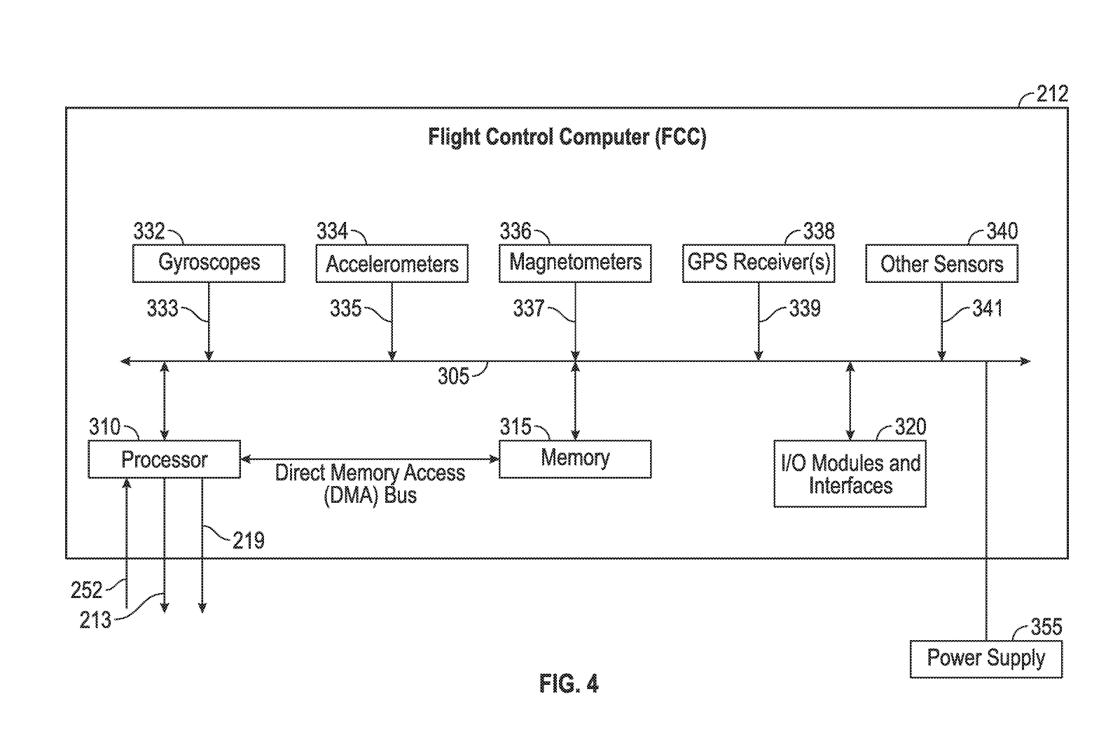

In accordance with the disclosed embodiments, any of the various sensors that are described above can be incorporated or integrated within the FCC 212 as indicated by sensor block 260. The sensors 260 incorporated or integrated within the FCC 212 can include sensors that are traditionally included to implement functions of the IRU 220, the AHRS 230, and the other sensors 240. Depending on the implementation, the sensors 260 can be redundant meaning that they are included in addition to the various sensors that are described above as being implemented as part of the IRU 220, the AHRS 230, and the other sensors 240, or can replace the various sensors that are described above as being implemented as part of the IRU 220, the AHRS 230, and the other sensors 240. An example implementation of a flight control computer will now be described with reference to FIG. 4.

FIG. 4 is a block diagram of a flight control computer 212 in accordance with one exemplary implementation of the disclosed embodiments. FIG. 4 will be described with reference to certain components described in conjunction with FIG. 3.

The flight control computer 212 includes a bus 305, a processor 310, a memory 315 that the processor 310 can access via a direct memory access bus 312, input/output modules and interfaces 320, and various sensors integrated within the flight control computer 212 including gyroscopes 332, accelerometers 334, magnetometers 336, one or more GPS receiver(s) 338 and other sensors 340. In some embodiments, the flight control computer 212 can also include wired and wireless communication interfaces (not illustrated) for communicating information with other systems onboard the aircraft 10 that are external to the flight control computer 212.

The bus 305 can carry power, data, status, control and other information or signals between the various blocks of FIG. 4. Power can be supplied to the flight control computer 212 and all of its internal elements via a power supply 355 that can be external or internal to the flight control computer 212, but is shown external to the flight control computer 212 in this particular embodiment. The bus 305 is used to carry information communicated between the processor 310, the memory 315, the gyroscopes 332, the accelerometers 334, the magnetometers 336, the GPS receiver(s) 338, the other sensors 340, various sub-systems and aircraft instrumentation (not illustrated in FIG. 4) that are external to the flight control computer flight control computer 212, cockpit output devices (not illustrated in FIG. 4), various input devices (not illustrated in FIG. 4), and communication network interfaces (not illustrated in FIG. 4).

The bus 305 can be implemented using any suitable physical and/or logical means of interconnecting the elements of the flight control computer 212 to at least the external and internal elements mentioned above. This includes, but is not limited to, direct hard-wired connections, fiber optics, and infrared and wireless bus technologies. Notably, the power supply 355 can supply power to the processor 310, the memory 315, the input/output modules and interfaces 320, the gyroscopes 332, the accelerometers 334, the magnetometers 336, the GPS receiver(s) 338, and the other sensors 340 via the bus 305. As such, the gyroscopes 332, the accelerometers 334, the magnetometers 336, the GPS receiver(s) 338, and the other sensors 340 do not need separate wired connections to the power supply 355. Moreover, all of the connections between the bus 305 and the gyroscopes 332, the accelerometers 334, the magnetometers 336, the GPS receiver(s) 338, and the other sensors 340 are internal to the flight control computer 212, which eliminates the need for external wiring that would normally be need between the flight control computer 212 and the gyroscopes, the accelerometers, the magnetometers, the GPS receiver(s), and any other sensors that are part of a IRU 220, AHRS 230, and other sensors 240 that the flight control computer 212 is connected to.

The processor 310 performs the computation and control functions of the flight control computer 212, and may comprise any type of processor 310 (or multiple processors), single integrated circuits such as a microprocessor, or any suitable number of integrated circuit devices and/or circuit boards working in cooperation to accomplish the functions of a processing unit. The processor 310 can use the input/output modules and interfaces 320 to provide information to external computers and devices, and can receive information from external computers and devices.

The memory 315 may be a single type of memory component, or it may be composed of many different types of memory components. The memory 315 can includes non-volatile memory (such as ROM, flash memory, etc.), volatile memory (such as RAM), or some combination of the two. The RAM can be any type of suitable random access memory including the various types of dynamic random access memory (DRAM) such as SDRAM, the various types of static RAM (SRAM). The RAM can include an operating system and executable code for flight control programs executed by the processor 310. The flight control programs (stored in system memory 315) that can be loaded via Direct Memory Access (DMA) bus 312 at the processor 310 and executed at processor 310 to implement various flight control functions.

The gyroscopes 332 can be the same or similar to those that are implemented as part of the IRU 220 and/or the AHRS 230. The gyroscopes 332 measure the various angular velocities of the aircraft in the inertial reference frame, and can provide angular velocity signals 333 to the processor 310. The aircraft's current orientation at any given time can be determined by using the original orientation of the aircraft in the inertial reference frame as an initial condition and integrating angular velocity.

The accelerometers 334 can be the same or similar to those that are implemented as part of the IRU 220 and/or the AHRS 230. The accelerometers 334 measure the linear acceleration of the aircraft in the inertial reference frame in directions relative to the moving aircraft, and can provide linear acceleration signals 335 to the processor 310.

The magnetometers 336 can be the same or similar to those that are implemented as part of the IRU 220 and/or the AHRS 230. The magnetometers 336 can provide signals 337 that indicate the magnetic heading of the aircraft.

The GPS receiver(s) 338 can provide GPS signals 339 indicating the position and speed of the aircraft.

The other sensors 340 can include, without limitation, one or more of acoustic sensors (e.g., sound, microphone, seismometer, accelerometer, etc.), vibration sensors, air data sensors (e.g., air speed indicator, altimeter, attitude indicator, navigation instrument sensor, speed sensors, angular rate sensors, etc.), position, angle, displacement, distance, speed, acceleration sensors (e.g., inclinometer, position sensor, rotary encoder, rotary/linear variable differential transformer, tachometer, etc.)

The processor 310 receives the signals 333, 335, 337, 339 and 341 from the various gyroscopes 332, accelerometers 334, magnetometers 336, GPS receiver(s) 338, and other sensors 340, and can process signals 333, 335, 337, 339 and 341 along with the pilot input signals 252 to translate the pilot input signals into engine control signals 219 and commands 213 for use by the actuator control unit(s) 214 to perform any of the flight control functions described above. For example, the processor 310 can perform processing that is the same or similar to that performed by the IRU 220 and/or the AHRS 230. Among other things, the processor can use the current angular velocity signals 333 and the current linear acceleration signals 335 to determine the linear acceleration of the aircraft in the inertial reference frame, and the inertial accelerations can be used to determine the inertial velocities of the aircraft, and inertial position of the aircraft.

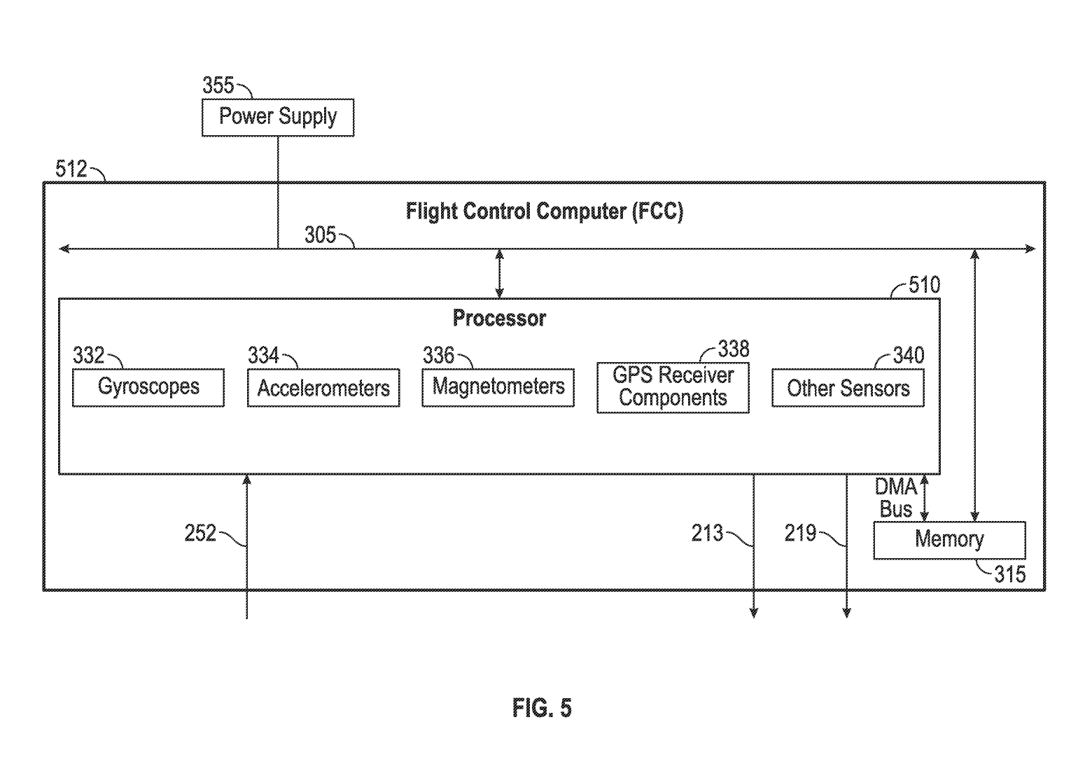

FIG. 5 is a block diagram of a flight control computer 512 having a processor 510 with integrated sensors in accordance with other disclosed embodiments. FIG. 5 will be described with reference to certain components that are already described above in conjunction with FIG. 4 and for sake of brevity the description of those components will not be repeated. In this implementation, various sensors are integrated within the processor 510 of the flight control computer 512. These sensors can include gyroscopes 332, accelerometers 334, magnetometers 336, GPS receiver components 338 and other sensors 340 that are integrated on and in the same die that the processor 512 is formed in and on. In one embodiment, the accelerometers 334, magnetometers 336, and other sensors 340 can be solid-state and/or microelectro-mechanical system (MEMS) devices.

In this embodiment, the gyroscopes 332, the accelerometers 334, the magnetometers 336, the GPS receiver(s) 338, and the other sensors 340 are part of the processor 510 and therefore do not need separate wired connections to the power supply 355, but can instead use power provided to the processor 510 via the bus 305. Moreover, there is not need for separate wired connections between the bus 305 and the gyroscopes 332, the accelerometers 334, the magnetometers 336, the GPS receiver(s) 338, and the other sensors 340 because those elements are internal to the processor 510, which eliminates the need for external wiring that would normally be need between the flight control computer 212 and the gyroscopes, the accelerometers, the magnetometers, the GPS receiver(s), and any other sensors that are part of a IRU 220, AHRS 230, and other sensors 240 that the flight control computer 212 is connected to.

The disclosed embodiments can provide an aircraft with equal or better safety than those that utilize previous fly-by-wire systems. In the event that operation of one or more of primary sensors (e.g., one of the sensors at the IRU 220, the AHRS 230, and the other sensors 240) degrades, the outputs generated by sensors 260 can be used to generate appropriate control surface commands needed to achieve the desired aircraft motion and flight control. When the sensors 260 incorporated or integrated within the flight control compute 212 are implemented as redundant sensors, the disclosed embodiments can provide a fly-by-wire aircraft that is easier to design and that is less costly to manufacture because the need for mounting redundant sensors throughout the aircraft can be eliminated. For example, the need for wiring to communicatively couple the redundant sensors to the flight control computer is eliminated. Moreover, because these redundant sensors can also be powered using power already available at the flight control computer, the need for additional wiring between the redundant sensors and power supplies can also be eliminated.

Those of skill in the art would further appreciate that the various illustrative logical blocks/tasks/steps, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. For example, although the disclosed embodiments are described with reference to a flight control computer of an aircraft, those skilled in the art will appreciate that the disclosed embodiments could be implemented in other types of computers that are used in other types of vehicles including, but not limited to, spacecraft, submarines, surface ships, automobiles, trains, motorcycles, etc. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A flight control computer, comprising:
an inertial sensor incorporated within the flight control computer.

2. The flight control computer according to claim 1, wherein the inertial sensor comprises:
an accelerometer.

3. The flight control computer according to claim 1, wherein the inertial sensor comprises:
a gyroscope.

4. The flight control computer according to claim 1, further comprising:
a magnetometer incorporated within the flight control computer.

5. The flight control computer according to claim 1, further comprising:
a processor, and wherein the inertial sensor is integrated within the processor of the flight control computer.

6. The flight control computer according to claim 1, further comprising:
a processor, wherein the inertial sensor is configured to generate inertial signal data that is processed by the processor to generate control commands.

7. The flight control computer according to claim 1, wherein the flight control computer provides power to the inertial sensor.

8. The flight control computer according to claim 1, wherein the inertial sensor is a first inertial sensor, wherein the flight control computer further comprises:
an interface that is configured to be coupled to a second inertial sensor that is external to the flight control computer.

9. The flight control computer according to claim 8, wherein the first inertial sensor is a redundant version of the second inertial sensor.

10. An aircraft, comprising:
a flight control computer, comprising:
an inertial sensor integrated within the flight control computer.

11. The aircraft according to claim 10, wherein the inertial sensor comprises:
an accelerometer.

12. The aircraft according to claim 10, wherein the inertial sensor comprises:
a gyroscope.

13. The aircraft according to claim 10, wherein the flight control computer further comprises:
a magnetometer integrated within the flight control computer.

14. The aircraft according to claim 10, wherein the flight control computer comprises:
a processor, and wherein the inertial sensor is integrated within the processor of the flight control computer.

15. The aircraft according to claim 10, wherein the flight control computer comprises:
a processor, wherein the inertial sensor is configured to generate inertial signal data that is processed by the processor to generate control commands that are used to control flight control surfaces of the aircraft.

16. The aircraft according to claim 10, further comprising:
a power supply that is configured to supply power to the flight control computer, and wherein the inertial sensor is configured to be powered by the power supplied to the flight control computer by the power supply.

17. The aircraft according to claim 10, wherein the inertial sensor is a first inertial sensor, and further comprising:
a second inertial sensor that is external to the flight control computer and that is coupled to the flight control computer via a wired connection.

18. The aircraft according to claim 17, wherein the first inertial sensor is a redundant version of the second inertial sensor.

19. The aircraft according to claim 18, wherein the flight control computer comprises:
a processor, wherein the first inertial sensor is configured to generate first inertial signal data, wherein the second inertial sensor is configured to generate second inertial signal data, and wherein the processor is configured to compare the first inertial sensor data to the second inertial sensor data to check validity of the second inertial sensor data.

20. The aircraft according to claim 19, further comprising:
at least one flight control surface, and
wherein the processor is configured to process the first inertial sensor data, when the processor determines that the second inertial sensor data is unavailable, to generate control commands that are used to control the flight control surface of the aircraft.
